(19) United States
(12) Patent Application Publication
(10) Pub. No.: US 2026/0185873 A1
(43) Pub. Date: Jul. 2, 2026

(54) HYPERSPECTRAL CAMERA LENS UNIT AND HYPERSPECTRAL CAMERA

(71) Applicant: HAMAMATSU PHOTONICS K.K., Hamamatsu-shi, Shizuoka (JP)

(72) Inventors: Hiroki OYAMA, Hamamatsu-shi, Shizuoka (JP); Katsumi SHIBAYAMA, Hamamatsu-shi, Shizuoka (JP); Takafumi YOKINO, Hamamatsu-shi, Shizuoka (JP); Takashi KASAHARA, Hamamatsu-shi, Shizuoka (JP); Yumi KURAMOTO, Hamamatsu-shi, Shizuoka (JP)

(73) Assignee: HAMAMATSU PHOTONICS K.K., Hamamatsu-shi, Shizuoka (JP)

(21) Appl. No.: 19/130,222

(22) PCT Filed: Dec. 6, 2023
(86) PCT No.: PCT/JP2023/043614

§ 371 Date: May 15, 2025

(30) Foreign Application Priority Data
Dec. 15, 2022 (JP) 2022-200026

(51) Int. Cl. G01J 3/28; G01J 3/02; G01J 3/26; G01J 3/32; H04N 23/12; H04N 23/55

(52) U.S. Cl. CPC G01J 3/2823; G01J 3/0202; G01J 3/0208; G01J 3/0229; G01J 3/26; G01J 3/32; H04N 23/12; H04N 23/55

(57) ABSTRACT

A lens portion includes a housing and an optical system disposed inside the housing. The optical system includes a Fabry-Perot interference filter, a first aperture which is formed integrally with the Fabry-Perot interference filter, and through which light traveling toward the Fabry-Perot interference filter or the light that has transmitted through the Fabry-Perot interference filter passes, a first lens portion that focuses or collimates the light traveling from an incident portion toward the Fabry-Perot interference filter, and a second lens portion that images the light that transmits through the Fabry-Perot interference filter and is emitted from an emitting portion. When viewed in an optical axis direction, a width of the light at an incident position on the first aperture is wider than a width of the first aperture.

### TECHNICAL FIELD

The present disclosure relates to a hyperspectral camera lens unit and a hyperspectral camera.

### BACKGROUND ART

There is a hyperspectral camera that spectrally separates light into wavelengths using a Fabry-Perot interference filter, and that image-captures the spectrally separated light. As a related technology, for example, Patent Literature 1 discloses an image capturing lens portion including an objective lens, an imaging lens, and a Fabry-Perot interference filter provided therebetween. Light guided by the image capturing lens portion is image-captured by an image capturing unit provided inside a camera body.

### CITATION LIST

### Patent Literature

Patent Literature 1: Japanese Unexamined Patent Publication No. 2016-11986

### SUMMARY OF INVENTION

### Technical Problem

An object of one aspect of the present disclosure is to provide a hyperspectral camera lens unit that enables a hyperspectral camera to satisfactorily capture an image, and a hyperspectral camera capable of satisfactorily capturing an image.

### Solution to Problem

A hyperspectral camera lens unit according to one aspect of the present disclosure is [1] “a hyperspectral camera lens unit including a housing including an incident portion on which light is incident, an emitting portion from which the light is emitted, and an attachment portion to which an optical device is detachably attached; and an optical system disposed inside the housing. The optical system includes a Fabry-Perot interference filter that includes a pair of mirror portions having a variable distance therebetween, and that transmits the light from the incident portion according to the distance between the pair of mirror portions, a first aperture which is formed integrally with the Fabry-Perot interference filter, and through which the light traveling toward the Fabry-Perot interference filter or the light that has transmitted through the Fabry-Perot interference filter passes, a first lens portion that focuses or collimates the light traveling from the incident portion toward the Fabry-Perot interference filter, and a second lens portion that images the light that transmits through the Fabry-Perot interference filter and is emitted from the emitting portion. When viewed in an optical axis direction, a width of the light at an incident position on the first aperture is wider than a width of the first aperture.

In the hyperspectral camera lens unit, when viewed in the optical axis direction of the light, the width of the light at the incident position on the first aperture is wider than the width of the first aperture. Accordingly, for example, compared to when the light narrowed by a lens to a width narrower than the width of the first aperture passes through the first aperture, the width of the first aperture can be utilized to the maximum extent, and the amount of light can be ensured. In addition, the light traveling toward the Fabry-Perot interference filter or the light that has transmitted through the Fabry-Perot interference filter can be narrowed by the first aperture, and the depth of field can be increased. In addition, the first aperture is formed integrally with the Fabry-Perot interference filter. Accordingly, for example, compared to when the first aperture is formed separately from the Fabry-Perot interference filter, the occurrence of deviations from the design (for example, a deviation in the distance or angle between the pair of mirror portions and the first aperture, a misalignment in a direction perpendicular to an optical axis, or the like) can be suppressed. As described above, the hyperspectral camera lens unit enables a hyperspectral camera to satisfactorily capture an image.

A hyperspectral camera lens unit according to one aspect of the present disclosure may be [2] “the hyperspectral camera lens unit described in [1], in which the Fabry-Perot interference filter is disposed at a position where a chief ray passing through an outer edge of an imaging region of the light formed by the second lens portion intersects an optical axis of the light.” In this case, the size of the imaging region of the light formed by the second lens can be keep constant regardless of the size of the first aperture. In addition, since the angle of incidence of the light on the Fabry-Perot interference filter becomes constant, it is becomes easy to correct the wavelength shift in the Fabry-Perot interference filter.

A hyperspectral camera lens unit according to one aspect of the present disclosure may be [3] “the hyperspectral camera lens unit described in [1] or [2], in which the first aperture is located on an incident portion side with respect to the pair of mirror portions.” In this case, stray light or light having a large angle of incidence can be cut by the first aperture before being incident on the pair of mirror portions, and noise can be reduced.

A hyperspectral camera lens unit according to one aspect of the present disclosure may be [4] “the hyperspectral camera lens unit described in any one of [1] to [3], in which the optical system further includes a second aperture disposed between the Fabry-Perot interference filter and the first lens portion or between the Fabry-Perot interference filter and the second lens portion.” In this case, the light can be narrowed to a desired angle range by the first aperture and the second aperture, and the resolution in capturing an image for each wavelength can be improved.

A hyperspectral camera lens unit according to one aspect of the present disclosure may be [5] “the hyperspectral camera lens unit described in [4], in which the second aperture is configured as an opening formed in a support, and the Fabry-Perot interference filter is fixed to the support.” In this case, the Fabry-Perot interference filter (first aperture) can be suitably fixed near the second aperture.

A hyperspectral camera lens unit according to one aspect of the present disclosure may be [6] “the hyperspectral camera lens unit described in [5] further including a first lens holder that holds the first lens portion; and a second lens holder that holds the second lens portion. The support is sandwiched and fixed between the first lens holder and the second lens holder.” In this case, the support can be suitably fixed.

A hyperspectral camera lens unit according to one aspect of the present disclosure may be [7] “the hyperspectral camera lens unit described in any one of [1] to [6], in which when viewed in the optical axis direction, an area of an incident region of the light at the incident position on the first aperture is equal to or less than 110% of an area of the first aperture.” In this case, the light utilization efficiency can be improved.

A hyperspectral camera lens unit according to one aspect of the present disclosure may be [8] “the hyperspectral camera lens unit described in any one of [1] to [7], in which the optical system further includes an additional optical system that is disposed between the Fabry-Perot interference filter and the first lens portion, and that reduces the width of the light.” In this case, the light utilization efficiency can be improved.

A hyperspectral camera lens unit according to one aspect of the present disclosure may be [9] “the hyperspectral camera lens unit described in any one of [1] to [7], in which the optical system further includes an additional optical system that is disposed between the Fabry-Perot interference filter and the first lens portion, and that collimates the light.” In this case, the occurrence of wavelength shift can be suppressed by collimating the light before being incident on the Fabry-Perot interference filter.

A hyperspectral camera lens unit according to one aspect of the present disclosure may be [10] “the hyperspectral camera lens unit described in [9], in which the additional optical system reduces the width of the light.” In this case, the light utilization efficiency can be improved.

A hyperspectral camera lens unit according to one aspect of the present disclosure may be [11] “the hyperspectral camera lens unit described in any one of [1] to [10], in which the Fabry-Perot interference filter includes a substrate including a first surface and a second surface opposite the first surface, and a first laminated structure disposed on the first surface. The first laminated structure includes a first laminate disposed on the first surface and including one of the pair of mirror portions, and a second laminate disposed on a side opposite the substrate with respect to the first laminate and including the other of the pair of mirror portions.” In this case as well, an image can be satisfactorily captured by the hyperspectral camera.

A hyperspectral camera lens unit according to one aspect of the present disclosure may be [12] “the hyperspectral camera lens unit described in [11], in which the Fabry-Perot interference filter further includes a second laminated structure disposed on the second surface of the substrate. A recess is formed on a surface of the second laminated structure opposite the substrate. At least a part of the recess overlaps the first aperture when viewed in the optical axis direction.” In this case, since the recess is formed, the light can easily transmit through a portion of the Fabry-Perot interference filter that overlaps the first aperture, and the light utilization efficiency can be improved.

A hyperspectral camera lens unit according to one aspect of the present disclosure may be [13] “the hyperspectral camera lens unit described in any one of [1] to [10], in which the Fabry-Perot interference filter includes a first substrate having a first surface, a second substrate having a second surface facing the first surface, one of the pair of mirror portions formed on the first surface, and the other of the pair of mirror portions formed on the second surface.” In this case as well, an image can be satisfactorily captured by the hyperspectral camera.

A hyperspectral camera lens unit according to one aspect of the present disclosure may be [14] “the hyperspectral camera lens unit described in any one of [1] to [13], in which the first aperture is formed by providing a light-shielding layer in a region of the Fabry-Perot interference filter other than a light-transmitting region while not providing the light-shielding layer in the light-transmitting region.” In this case, the first aperture can be formed integrally with the Fabry-Perot interference filter.

A hyperspectral camera according to one aspect of the present disclosure is [15] “the hyperspectral camera lens unit described in any one of [1] to [14]; and a camera unit that is the optical device attached to the attachment portion of the housing, the camera unit including an image capturing element that image-captures the light emitted from the emitting portion.” For the reasons described above, the hyperspectral camera can satisfactorily capture an image.

### Advantageous Effects of Invention

According to one aspect of the present disclosure, it is possible to provide the hyperspectral camera lens unit that enables the hyperspectral camera to satisfactorily capture an image, and the hyperspectral camera capable of satisfactorily capturing an image.

### BRIEF DESCRIPTION OF DRAWINGS

FIG. 1 is a configuration view of a hyperspectral camera according to an embodiment.

FIG. 2 is a perspective view of a filter unit.

FIG. 3 is a cross-sectional view of the filter unit taken along line III-III in FIG. 2.

FIG. 4 is a perspective view of a Fabry-Perot interference filter.

FIG. 5 is a cross-sectional view of the Fabry-Perot interference filter taken along line V-V in FIG. 4.

(a) and (b) in FIG. 6 are views for describing control of the angle of incidence by a first aperture and a second aperture.

FIG. 7 is a configuration view of a first modification example.

FIG. 8 is a configuration view of a second modification example.

FIG. 9 is a cross-sectional view of a Fabry-Perot interference filter of a third modification example.

(a) and (b) in FIG. 10 are views for describing other modification examples.

(a) and (b) in FIG. 11 are views for describing other modification examples.

(a) and (b) in FIG. 12 are views for describing other modification examples.

FIG. 13 is a view for describing another modification example.

### DESCRIPTION OF EMBODIMENTS

Hereinafter, an embodiment of the present disclosure will be described in detail with reference to the drawings. In the following description, the same reference signs are used for the same or corresponding elements, and duplicate descriptions will be omitted.

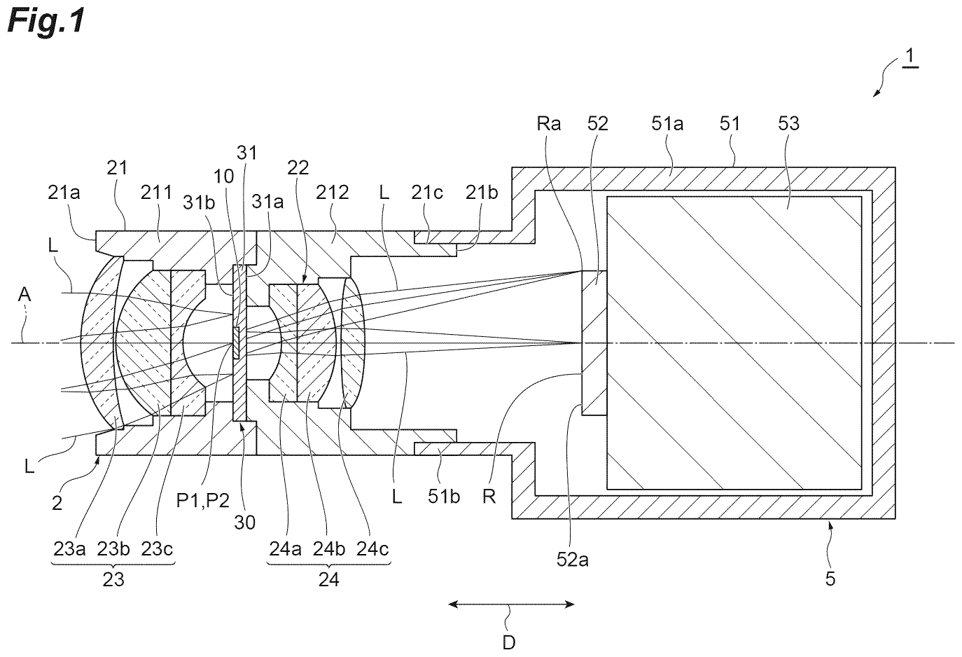

As shown in FIG. 1, a hyperspectral camera 1 includes a lens unit 2 (hyperspectral camera lens unit) and a camera unit 5 (optical device). The lens unit 2 is a replaceable lens device that is replaceably (detachably) attached to the camera unit 5. The hyperspectral camera 1 is a camera capable of spectrally separating light into several tens of bands to several hundreds of bands according to wavelength and acquiring an image for each band.

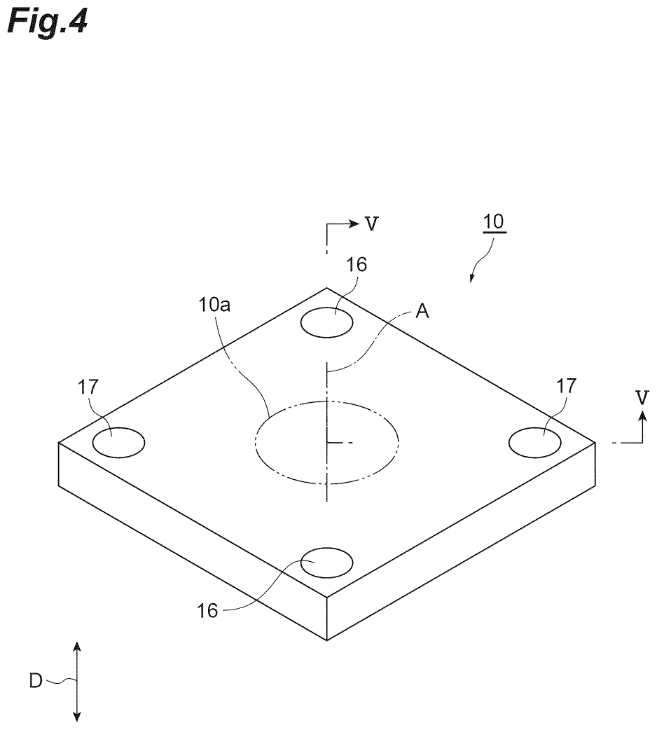

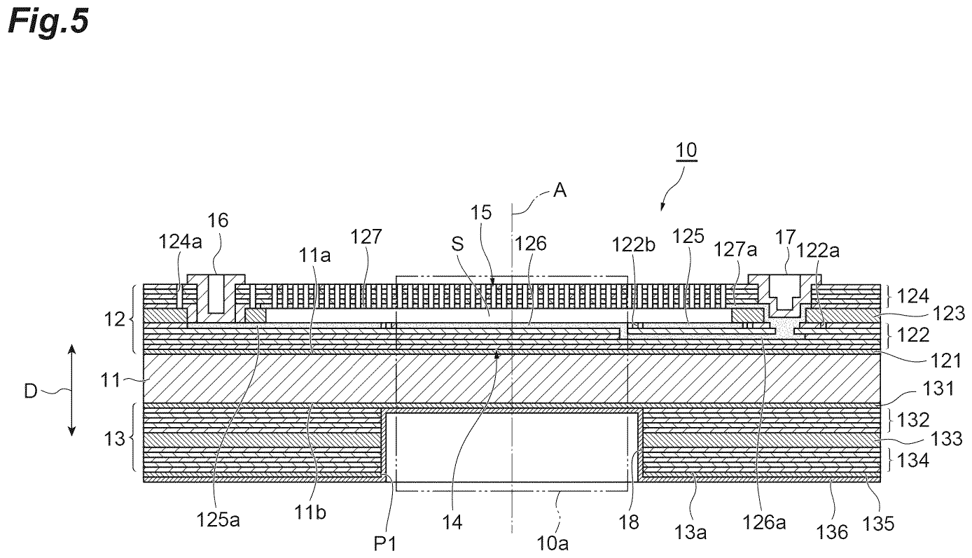

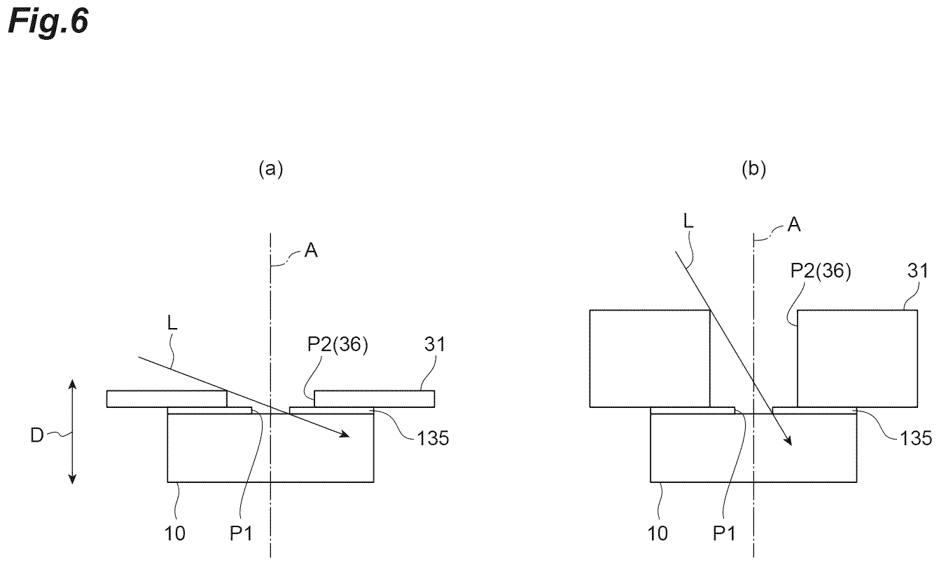

The lens unit 2 includes a housing 21 and an optical system 22 disposed inside the housing 21. The optical system 22 includes a Fabry-Perot interference filter 10, a first lens portion 23, and a second lens portion 24. The Fabry-Perot interference filter 10 is fixed to a support 31, and constitutes a filter unit 30, together with the support 31. The camera unit 5 includes a housing 51 and an image capturing element 52 disposed inside the housing 51. In the hyperspectral camera 1, light L focused by the first lens portion 23 transmits through the Fabry-Perot interference filter 10 along an optical axis direction D. The light L that has transmitted through the Fabry-Perot interference filter 10 is imaged by the second lens portion 24, and is image-captured by the image capturing element 52. Hereinafter, first, the Fabry-Perot interference filter 10 will be described with reference to FIGS. 4 and 5.

### Fabry-Perot Interference Filter

As shown in FIG. 4, the Fabry-Perot interference filter 10 has a light-transmitting region 10a. The Fabry-Perot interference filter 10 is a rectangular plate-shaped element. As will be described later, the Fabry-Perot interference filter 10 is disposed such that a thickness direction is parallel to the optical axis direction D. The light-transmitting region 10a is a columnar region having a center line parallel to the optical axis direction D. When viewed in the optical axis direction D, the center of the light-transmitting region 10a coincides with the center of the Fabry-Perot interference filter 10.

As shown in FIG. 5, the Fabry-Perot interference filter 10 includes a substrate 11 having the optical axis direction D as the thickness direction. The material of the substrate 11 is, for example, silicon, quartz, glass, or the like. The substrate 11 has a first surface 11a and a second surface 11b opposite the first surface 11a. The first surface 11a and the second surface 11b are, for example, flat surfaces perpendicular to the optical axis direction D. A first laminated structure 12 is laminated on the first surface 11a, and a second laminated structure 13 is laminated on the second surface 11b.

The first laminated structure 12 includes an anti-reflection layer 121, a first laminate 122, an intermediate layer 123, and a second laminate 124. The anti-reflection layer 121, the first laminate 122, the intermediate layer 123, and the second laminate 124 are laminated in order on the first surface 11a of the substrate 11. Namely, the first laminate 122 is disposed on the first surface 11a via the anti-reflection layer 121, and the second laminate 124 is disposed on a side opposite the substrate with respect to first laminate 122 (an upper side in FIG. 5). An air gap S is formed between the first laminate 122 and the second laminate 124 by the intermediate layer 123 having a frame shape. When the material of the substrate 11 is silicon, the material of each of the anti-reflection layer 121 and the intermediate layer 123 is, for example, silicon oxide or the like. A thickness of the intermediate layer 123 is, for example, an integer multiple of ½ of a design central wavelength. Note that, the thickness of the intermediate layer 123 may be larger than an integer multiple of ½ of the design central wavelength, if necessary.

A portion of the first laminate 122 that corresponds to the light-transmitting region 10a functions as a mirror portion 14. Namely, the first laminate 122 includes the mirror portion 14. The mirror portion 14 is supported by the substrate 11 via the anti-reflection layer 121. As one example, the first laminate 122 is configured by alternately laminating a plurality of polysilicon layers and a plurality of silicon nitride layers one by one. An optical thickness of each layer constituting the mirror portion 14 is, for example, an integer multiple of ¼ of the design central wavelength. Note that, a silicon oxide layer may be used instead of the silicon nitride layer.

A portion of the second laminate 124 that corresponds to the light-transmitting region 10a functions as a mirror portion 15. Namely, the second laminate 124 includes the mirror portion 15. The mirror portion 15 is supported by the substrate 11 via the anti-reflection layer 121, the first laminate 122, and the intermediate layer 123, and faces the mirror portion 14 in the optical axis direction D with the air gap S therebetween. As one example, the second laminate 124 is configured by alternately laminating a plurality of polysilicon layers and a plurality of silicon nitride layers one by one. An optical thickness of each layer constituting the mirror portion 15 is, for example, an integer multiple of ¼ of the design central wavelength. Note that, a silicon oxide layer may be used instead of the silicon nitride layer. Note that, a plurality of through-holes are formed in a portion of the second laminate 124, which corresponds to the air gap S, to an extent that the function of the mirror portion 15 is not substantially affected. The plurality of through-holes are used when the air gap S is formed by removing a part of the intermediate layer 123 through etching.

A first electrode 125 and a second electrode 126 are formed in the mirror portion 14. The first electrode 125 surrounds the light-transmitting region 10a when viewed in the optical axis direction D. The second electrode 126 overlaps the light-transmitting region 10a when viewed in the optical axis direction D. The shape of the second electrode 126 when viewed in the optical axis direction D is substantially the same as the shape of the light-transmitting region 10a when viewed in the optical axis direction D. Each of the first electrode 125 and the second electrode 126 is formed by doping a part of a polysilicon layer with an impurity to lower the resistance of that portion.

A third electrode 127 is formed in the mirror portion 15. The third electrode 127 faces the first electrode 125 and the second electrode 126 with the air gap S therebetween. The third electrode 127 is formed by doping a portion of a polysilicon layer with an impurity to reduce the resistance of that portion. As one example, a distance between the second electrode 126 and the third electrode 127 is substantially the same as a distance between the first electrode 125 and the third electrode 127.

A pair of terminals 16 are provided on the first laminated structure 12 so as to interpose the light-transmitting region 10a therebetween (refer to FIG. 4). Each of the terminals 16 is disposed in a through-hole that is formed in the second laminate 124 and the intermediate layer 123 so as to open to the side opposite the substrate 11 and reach the first laminate 122. Each of the terminals 16 is electrically connected to the first electrode 125 via a wiring 125a.

A pair of terminals 17 are provided on the first laminated structure 12 so as to interpose the light-transmitting region 10a therebetween (refer to FIG. 4). Each of the terminals 17 is disposed in a through-hole that is formed in the second laminate 124 and the intermediate layer 123 so as to open to the side opposite the substrate 11 and reach the intermediate layer 123. Each of the terminals 17 is electrically connected to the second electrode 126 via a wiring 126a, and is electrically connected to the third electrode 127 via a wiring 127a. Note that, a direction in which the pair of terminals 17 interpose the light-transmitting region 10a therebetween is a direction perpendicular to a direction in which the pair of terminals 16 interpose the light-transmitting region 10a therebetween (refer to FIG. 4).

A pair of trenches 122a are formed in the first laminate 122. Each of the trenches 122a extends in an annular shape so as to surround a portion of the wiring 126a, the portion extending from each of the terminals 17 in the optical axis direction D. Each of the trenches 122a electrically insulates the first electrode 125 from the wiring 126a. A trench 122b is formed in the first laminate 122. The trench 122b extends in an annular shape along an inner edge of the first electrode 125. The trench 122b electrically insulates the first electrode 125 from the second electrode 126. A region in each of the trenches 122a and 122b may be filled with an insulating material or may be an air gap.

A pair of trenches 124a are formed in the second laminate 124. Each of the trenches 124a extends in an annular shape so as to surround each of the terminals 16. Each of the trenches 124a electrically insulates each of the terminals 16 from the third electrode 127. A region in each of the trenches 124a may be filled with an insulating material or may be an air gap.

The second laminated structure 13 includes an anti-reflection layer 131, a third laminate 132, an intermediate layer 133, and a fourth laminate 134. The anti-reflection layer 131, the third laminate 132, the intermediate layer 133, and the fourth laminate 134 are laminated in order on the second surface 11b of the substrate 11. The anti-reflection layer 131 and the intermediate layer 133 have the same configurations as the anti-reflection layer 121 and the intermediate layer 123, respectively. The third laminate 132 and the fourth laminate 134 have laminated structures symmetrical to the first laminate 122 and the second laminate 124 with the substrate 11 as a reference, respectively. The anti-reflection layer 131, the third laminate 132, the intermediate layer 133, and the fourth laminate 134 have the function of suppressing warping of the substrate 11.

A recess 18 is formed on a surface 13a of the second laminated structure 13 opposite the substrate 11. The recess 18 opens to a side opposite the substrate 11. The recess 18 overlaps the light-transmitting region 10a when viewed in the optical axis direction D. The shape of the recess 18 when viewed in the optical axis direction D is substantially the same as the shape of the light-transmitting region 10a when viewed in the optical axis direction D, and is a circular shape in this example. A center line of the recess 18 coincides with a center line of the light-transmitting region 10a. The recess 18 is formed in the third laminate 132, the intermediate layer 133, and the fourth laminate 134, and reaches the anti-reflection layer 131.

A light-shielding layer 135 is formed on the surface 13a of the second laminated structure 13. The light-shielding layer 135 is formed, for example, over the entirety of the surface 13a. The material of the light-shielding layer 135 is, for example, aluminum or the like. The light-shielding layer 135 shields the light L. In this example, the light-shielding layer 135 shields the light L by reflecting the light L. On the other hand, the light L passes through a region where the light-shielding layer 135 is not formed (in this example, a region where the recess 18 is formed). Namely, the light-transmitting region 10a corresponds to the region where the light-shielding layer 135 is not formed. In such a manner, in the Fabry-Perot interference filter 10, a first aperture P1 that defines the light-transmitting region 10a is formed by the light-shielding layer 135. Namely, the first aperture P1 is formed by providing the light-shielding layer 135 in a region of the Fabry-Perot interference filter 10 other than the light-transmitting region 10a when viewed in the optical axis direction D while not providing the light-shielding layer 135 in the light-transmitting region 10a. In addition, the first aperture P1 is formed integrally with the Fabry-Perot interference filter 10. The width of the first aperture P1 is fixed (does not change).

The first aperture P1 is formed in a circular shape when viewed in the optical axis direction D. The entirety of the recess 18 overlaps the first aperture P1 when viewed in the optical axis direction D. In this example, the shape of the recess 18 when viewed in the optical axis direction D is substantially the same as the shape of the first aperture P1 when viewed in the optical axis direction D. The center line of the recess 18 coincides with a center line of the first aperture P1.

A protection layer 136 is formed on the light-shielding layer 135 and an inner surface of the recess 18. The material of the protection layer 136 is, for example, aluminum oxide or the like. Note that, the optical influence of the protection layer 136 can be ignored by setting the thickness of the protection layer 136 to 100 nm or less (preferably, approximately 30 nm).

In the Fabry-Perot interference filter 10 configured as described above, when a potential difference is generated between the first electrode 125 and the third electrode 127 by applying a voltage to the first electrode 125 and the third electrode 127 via the plurality of terminals 16 and 17, an electrostatic force corresponding to the potential difference is generated between the first electrode 125 and the third electrode 127. Due to the generation of an electrostatic force between the first electrode 125 and the third electrode 127, the mirror portion 15 is attracted to the mirror portion 14, and the distance between the mirror portion 14 and the mirror portion 15 is adjusted. At this time, the second electrode 126 that is at the same potential as the third electrode 127 functions as a compensation electrode, and the mirror portion 15 is kept flat in the light-transmitting region 10a.

In such a manner, in the Fabry-Perot interference filter 10, a pair of the mirror portions 14 and 15 facing each other in the optical axis direction D function as a pair of mirror portions between which the distance is variable. Here, the wavelength of light transmitting through the Fabry-Perot interference filter 10 depends on the distance between the mirror portion 14 and the mirror portion 15. Therefore, the wavelength of light transmitting through the Fabry-Perot interference filter 10 can be selected by adjusting the voltage applied to the first electrode 125 and the third electrode 127 (the potential difference generated between the first electrode 125 and the third electrode 127). In such a manner, the Fabry-Perot interference filter 10 transmits light, which has a wavelength corresponding to the distance between the mirror portions 14 and 15, out of the incident light.

### Filter Unit

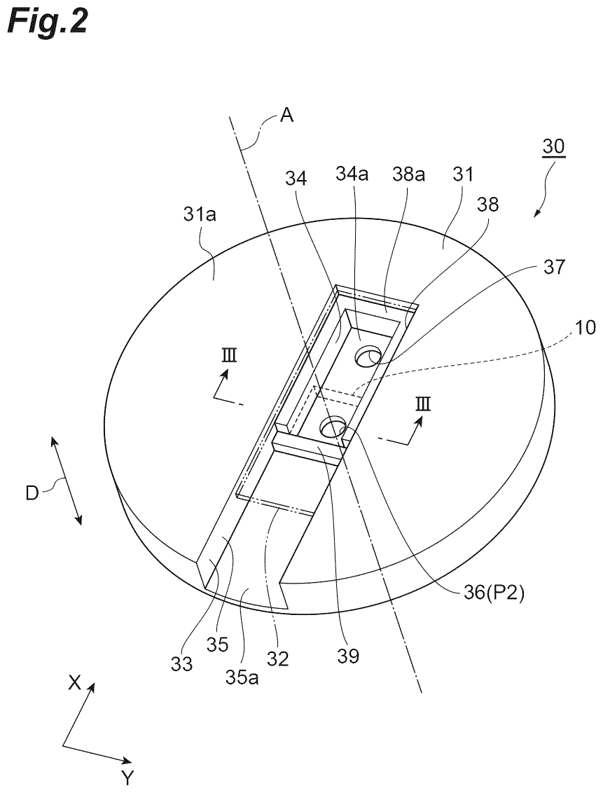

As shown in FIGS. 1 to 3, the filter unit 30 includes the support 31 (aperture plate), the Fabry-Perot interference filter 10 described above, and a bandpass filter 32. As will be described later, the filter unit 30 is disposed such that the thickness direction of the Fabry-Perot interference filter 10 is parallel to the optical axis direction D. In FIG. 2, the Fabry-Perot interference filter 10 is shown by dashed lines, and the bandpass filter 32 is shown by two-dot chain lines.

The support 31 is formed, for example, in a substantially circular plate shape from a metal material such as stainless steel. The support 31 has a first surface 31a and a second surface 32b opposite the first surface 31a. The first surface 31a and the second surface 31b are, for example, flat surfaces perpendicular to the optical axis direction D. A recess 33 for disposing the Fabry-Perot interference filter 10 and the bandpass filter 32 is formed in the support 31. The recess 33 is formed on the first surface 31a, and opens to the first surface 31a.

The recess 33 includes a first recess 34 and a second recess 35. A bottom surface 34a of the first recess 34 and a bottom surface 35a of the second recess 35 are located on the same plane perpendicular to the optical axis direction D. The first recess 34 and the second recess 35 are arranged in an X direction (a direction perpendicular to the optical axis direction D).

When viewed in the optical axis direction D, each of the first recess 34 and the second recess 35 is formed in a rectangular shape. In this example, when viewed in the optical axis direction D, each of the first recess 34 and the second recess 35 is formed in an oblong shape having the X direction as a longitudinal direction. When viewed in the optical axis direction D, the first recess 34 does not reach an outer edge of the support 31; however, the second recess 35 reaches the outer edge of the support 31. Namely, the second recess 35 opens to a side surface of the support 31.

A width of the second recess 35 in a Y direction (a direction perpendicular to both the optical axis direction D and the X direction) is larger than a width of the first recess 34 in the Y direction. An opening 36 and a through-hole 37 are formed in the support 31. Each of the opening 36 and the through-hole 37 open to the bottom surface 34a of the first recess 34 and the second surface 31b of the support 31. The opening 36 and the through-hole 37 are arranged in the X direction. When viewed in the optical axis direction D, each of the opening 36 and the through-hole 37 is formed, for example, in a circular shape. The opening 36 constitutes a second aperture P2 through which the light L traveling toward the Fabry-Perot interference filter 10 passes. In this example, a diameter (width) of the second aperture P2 is larger than a diameter (width) of the first aperture P1. The width of the second aperture P2 is fixed (does not change). The through-hole 37 is used, for example, to allow gas, which is generated from an adhesive material for fixing the Fabry-Perot interference filter 10 and the bandpass filter 32, to escape during the manufacture of the filter unit 30.

A widened portion 38 is formed in the support 31. The widened portion 38 is widened to a side opposite the second recess 35 in the X direction and to both sides in the Y direction with respect to an opening of the first recess 34. The widened portion 38 is a recess that is formed in the support 31 so as to open to the first surface 31a and reach the opening of the first recess 34 with the optical axis direction D as a depth direction. In the present embodiment, a width of the widened portion 38 in the Y direction is equal to the width of the second recess 35 in the Y direction.

The support 31 includes a partition portion 39. The partition portion 39 is disposed between the first recess 34 and the second recess 35. In the present embodiment, the partition portion 39 is a wall portion extending in the Y direction between the bottom surface 34a of the first recess 34 and the bottom surface 35a of the second recess 35. When a plane on which the bottom surface 34a and the bottom surface 35a are located is taken as a reference, a height of the partition portion 39 in the optical axis direction D is lower than a height of the first surface 31a of the support 31 in the optical axis direction D, and is lower than a height of a bottom surface 38a of the widened portion 38 in the optical axis direction D.

The Fabry-Perot interference filter 10 is disposed on the support 31 so as to overlap the second aperture P2 (opening 36) when viewed in the optical axis direction D and such that the thickness direction is parallel to the optical axis direction D. More specifically, the Fabry-Perot interference filter 10 is disposed inside the first recess 34 so as to overlap the opening 36 when viewed in the optical axis direction D and such that the thickness direction is parallel to the optical axis direction D. The Fabry-Perot interference filter 10 is in contact with the partition portion 39 inside the first recess 34. When the bottom surface 34a of the first recess 34 is taken as a reference, a height of the Fabry-Perot interference filter 10 in the optical axis direction D is lower than the height of the first surface 31a of the support 31 in the optical axis direction D, and is lower than the height of the bottom surface 38a of the widened portion 38 in the optical axis direction D. When the bottom surface 34a of the first recess 34 is taken as a reference, the height of the partition portion 39 in the optical axis direction D is equal to or less than the height of the Fabry-Perot interference filter 10 in the optical axis direction D.

As described above, the Fabry-Perot interference filter 10 is a rectangular plate-shaped element having the optical axis direction D as the thickness direction. The Fabry-Perot interference filter 10 is disposed on the bottom surface 34a of the first recess 34 such that, when viewed in the optical axis direction D, each side of an outer edge of the rectangular shape is parallel to the X direction or the Y direction and the first aperture P1 faces the second aperture P2 (opening 36). The Fabry-Perot interference filter 10 is fixed to the bottom surface 34a by, for example, an adhesive material. The center line of the first aperture P1 coincides with a center line of the second aperture P2.

The bandpass filter 32 is disposed on the support 31 so as to cover the opening of the first recess 34 and such that a thickness direction is parallel to the optical axis direction D. More specifically, the bandpass filter 32 is disposed inside the widened portion 38 so as to cover the opening of the first recess 34 and such that the thickness direction is parallel to the optical axis direction D. The bandpass filter 32 is fixed to the bottom surface 38a of the widened portion 38 by, for example, an adhesive material. In the present embodiment, the bandpass filter 32 covers the opening of the first recess 34 and covers a part of an opening of the second recess 35. When the bottom surface 38a of the widened portion 38 is taken as a reference, a height of the bandpass filter 32 in the optical axis direction D is lower than the height of the first surface 31a of the support 31 in the optical axis direction D.

The bandpass filter 32 is formed in a rectangular plate shape having the optical axis direction D as the thickness direction and the X direction as a longitudinal direction. The bandpass filter 32 is disposed on the bottom surface 38a of the widened portion 38 such that each side of an outer edge of the rectangular shape is parallel to the X direction or the Y direction when viewed in the optical axis direction D. The bandpass filter 32 transmits light in a predetermined wavelength range. In addition, although not shown in the figures, for example, a wiring board or the like that is electrically connected to the Fabry-Perot interference filter 10 is disposed in the second recess 35.

### Lens Unit and Camera Unit

As shown in FIG. 1, the lens unit 2 includes the housing 21 and the optical system 22 disposed inside the housing 21. The optical system 22 includes the Fabry-Perot interference filter 10 described above, the first lens portion 23, and the second lens portion 24. In addition, the optical system 22 further includes the first aperture P1 and the second aperture P2 described above.

The housing 21 is formed, for example, in a substantially cylindrical shape. The housing 21 includes an incident portion 21a on which the light L is incident; an emitting portion 21b from which the light L is emitted; and an attachment portion 21c to which the camera unit 5 is detachably attached. In this example, the incident portion 21a is configured by an end portion on one side of the housing 21 in the optical axis direction D, and the emitting portion 21b is configured by an end portion on the other side of the housing 21 in the optical axis direction D. In the lens unit 2, the light L incident from the incident portion 21a is guided along the optical axis direction D by the optical system 22, and is emitted from the emitting portion 21b toward the camera unit 5.

The attachment portion 21c is provided at the end portion on an emitting portion 21b side of the housing 21 (end portion on the other side in the optical axis direction D). The attachment portion 21c detachably engages with an attachment portion 51b of the camera unit 5 to be described later. For example, when the lens unit 2 and the camera unit 5 are detachably attached together by screwing, the attachment portion 21c is provided with one of a screw thread and a screw groove, and the attachment portion 51b is provided with the other of a screw thread and a screw groove that screws with the one.

In this example, the housing 21 is divided in the optical axis direction D, and includes a first portion 211 disposed on the one side in the optical axis direction D, and a second portion 212 disposed on the other side in the optical axis direction D. The first portion 211 constitutes a first lens holder that holds the first lens portion 23, and the second portion 212 constitutes a second lens holder that holds the second lens portion 24. In the present embodiment, the support 31 of the filter unit 30 is sandwiched and fixed between the first portion 211 and the second portion 212. For example, the first portion 211 is in contact with the first surface 31a of the support 31, and the second portion 212 is in contact with the second surface 31b of the support 31.

Accordingly, the Fabry-Perot interference filter 10 is fixed on an optical axis A between the first lens portion 23 and the second lens portion 24. The filter unit 30 is fixed on the optical axis A such that the center line of the light-transmitting region 10a of the Fabry-Perot interference filter 10, the center line of the first aperture P1, and the center line of the second aperture P2 are located on the optical axis A (refer to FIGS. 1 to 5). In this fixed state, the second surface 31b of the support 31 faces the incident portion 21a side, and the first aperture P1 is located on the incident portion 21a side with respect to the mirror portions 14 and 15 of the Fabry-Perot interference filter 10. The second aperture P2 is located between the first lens portion 23 and the Fabry-Perot interference filter 10. Namely, the second aperture P2 is located on the incident portion 21a side with respect to the first aperture P1.

The first lens portion 23 is a focusing optical system that focuses the light L traveling from the incident portion 21a toward the Fabry-Perot interference filter 10. The first lens portion 23 includes at least one lens, and in this example, includes three lenses 23a, 23b, and 23c (lens group) arranged along the optical axis direction D (direction parallel to the optical axis A). The first lens portion 23 is fitted and fixed to the first portion 211 of the housing 21 at an outer peripheral portion of the first lens portion 23. Note that, the first lens portion 23 may be fixed to the housing 21 by fixing a fixing ring, which is attached to the outer peripheral portion of the first lens portion 23, to the first portion 211 of the housing 21 using screws or the like.

The second lens portion 24 is an imaging optical system that images the light L that transmits through the Fabry-Perot interference filter 10 and is emitted from the emitting portion 21b. The second lens portion 24 includes at least one lens, and in this example, includes three lenses 24a, 24b, and 24c (lens group) arranged along the optical axis direction D. The second lens portion 24 is fitted and fixed to the second portion 212 of the housing 21 at an outer peripheral portion of the second lens portion 24. Note that, the second lens portion 24 may be fixed to the housing 21 by fixing a fixing ring, which is attached to the outer peripheral portion of the second lens portion 24, to the second portion 212 of the housing 21 using screws or the like.

The camera unit 5 includes the housing 51 and the image capturing element 52 disposed inside the housing 51. The housing 51 includes a body portion 51a having a bottom surface, and the attachment portion 51b. The attachment portion 51b is formed in a cylindrical shape that is one size smaller than the body portion 51a. The attachment portion 51b detachably engages with the attachment portion 21c of the lens unit 2 described above.

The image capturing element 52 is disposed inside the body portion 51a of the housing 51. The image capturing element 52 is, for example, an InGaAs image sensor. The image capturing element 52 has a light-receiving surface 52a disposed on an imaging plane of the light L formed by the second lens portion 24, and image-captures the light L emitted from the emitting portion 21b. In addition, a control circuit for controlling the image capturing element 52, an image processing circuit for processing an image acquired by the image capturing element 52, a cooling mechanism for cooling the image capturing element 52, and the like are further disposed inside the body portion 51a. In FIG. 1, these components are denoted by reference sign 53.

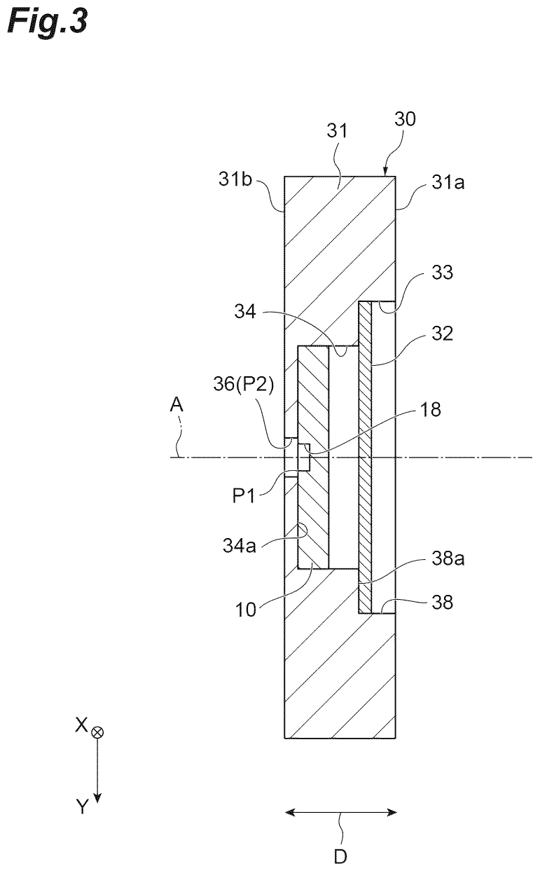

In the hyperspectral camera 1, the light L incident from the incident portion 21a is focused by the first lens portion 23, and travels toward the filter unit 30 (refer to FIGS. 1 and 3). The light L traveling toward the filter unit 30 passes or transmits through the second aperture P2, the first aperture P1, the mirror portions 14 and 15, and the bandpass filter 32 in order (refer to FIGS. 1, 3, and 5). The light L is spectrally separated according to wavelength when transmitting through the Fabry-Perot interference filter 10 (mirror portions 14 and 15). The light L emitted from the filter unit 30 (bandpass filter 32) is imaged on the light-receiving surface 52a of the image capturing element 52 by the second lens portion 24, and is image-captured by the image capturing element 52.

In the hyperspectral camera 1, the Fabry-Perot interference filter 10 (first aperture P1) is disposed at a position where a chief ray passing through an outer edge Ra of an imaging region R of the light L formed by the second lens portion 24 intersects the optical axis A. Namely, the Fabry-Perot interference filter 10 is disposed at the position of a diaphragm of the optical system 22, and functions as a diaphragm. In this example, the optical system 22 is configured as a double-sided non-telecentric optical system, and the Fabry-Perot interference filter 10 is disposed away from the first lens portion 23 by the focal length of the first lens portion 23, and is disposed away from the second lens portion 24 by the focal length of the second lens portion 24. The Fabry-Perot interference filter 10 is disposed such that the incident position of the light L on the first aperture P1 coincides with the position where the chief ray passing through the outer edge Ra of the imaging region R intersects the optical axis A. Note that, the chief ray is a ray passing through the center of the diaphragm (first aperture P1).

In the hyperspectral camera 1, when viewed in the optical axis direction D, a width (spot width) of the light L at an incident position on the first aperture P1 is wider than the width of the first aperture P1. Accordingly, the light L traveling toward the Fabry-Perot interference filter 10 (mirror portions 14 and 15) can be narrowed by the first aperture P1. In this example, the light L has a circular shape with a diameter of 1.6 mm at the incident position on the first aperture P1, and the first aperture P1 has a circular shape with a diameter of 1.5 mm. When viewed in the optical axis direction D, the area of an incident region of the light L at the incident position on the first aperture P1 may be equal to or less than 110% of the area of the first aperture P1. Note that, in the present embodiment, the width of the light L at the incident position on the first aperture P1 is wider than the width of the first aperture P1 in all directions perpendicular to the optical axis direction D; however, it is sufficient if the width of the light L at the incident position on the first aperture P1 is wider than the width of the first aperture P1 in at least one direction perpendicular to the optical axis direction D.

FIG. 6 is a view for describing control of the angle of incidence by the first aperture P1 and the second aperture P2. In FIG. 6, each element is schematically shown. As described above, in the hyperspectral camera 1, the second aperture P2 is located on the incident portion 21a side (upper side in FIG. 6) with respect to the first aperture P1, and the diameter (width) of the second aperture P2 is larger than the diameter (width) of the first aperture P1. Therefore, the light L from the incident portion 21a passes through the second aperture P2 and then passes through the first aperture P1. In a case where the width of the light L at the incident position on the second aperture P2 is wider than the width of the second aperture P2 when viewed in the optical axis direction D, the light L from the incident portion 21a is narrowed by the second aperture P2 and then is narrowed by the first aperture P1. By implementing a double aperture structure, in which the first aperture P1 and the second aperture P2 are provided, in such a manner, not only can the light L be narrowed by the first aperture P1, but the angle of incidence of the light L with respect to the Fabry-Perot interference filter 10 can also be controlled by the second aperture P2.

For example, when the thickness (depth) of the second aperture P2 is made thin as shown in (a) of FIG. 6, the light L having a relatively large angle of incidence is allowed to be incident on the Fabry-Perot interference filter 10. On the other hand, when the thickness of the second aperture P2 is made thick as shown in (b) of FIG. 6, the incidence of the light L having a relatively large angle of incidence on the Fabry-Perot interference filter 10 is restricted compared to the case of (a) in FIG. 6. In such a manner, the angle of incidence of the light L with respect to the Fabry-Perot interference filter 10 can be controlled by adjusting the thickness of the second aperture P2.

### Functions and Effects

In the lens unit 2, when viewed in the optical axis direction D, the width of the light L at the incident position on the first aperture P1 is wider than the width of the first aperture P1. Accordingly, for example, compared to when the light L narrowed by a lens to a width narrower than that of the first aperture P1 passes through the first aperture P1, the width of the first aperture P1 can be utilized to the maximum extent, and the amount of light can be ensured. In addition, the light L traveling toward the Fabry-Perot interference filter 10 can be narrowed by the first aperture P1, and the depth of field can be increased. The influence of focus shift can be reduced by increasing the depth of field. In addition, the first aperture P1 is formed integrally with the Fabry-Perot interference filter 10. Accordingly, for example, compared to when the first aperture P1 is formed separately from the Fabry-Perot interference filter 10, the occurrence of deviations from the design (for example, a deviation in the distance or angle between the pair of mirror portions 14 and 15 and the first aperture P1, a misalignment in the direction perpendicular to the optical axis A, or the like) can be suppressed. As described above, the lens unit 2 enables the hyperspectral camera 1 to satisfactorily capture an image. In addition, since the Fabry-Perot interference filter 10 constitutes the lens unit 2, and the lens unit 2 and the camera unit 5 can be attached to and detached from each other, the degree of freedom of selection of the camera unit 5 can be increased. In addition, since the Fabry-Perot interference filter 10 is disposed between the first lens portion 23 and the second lens portion 24, the overall length along the optical axis direction D can be shortened, for example, compared to when the Fabry-Perot interference filter 10 is disposed between the second lens portion 24 and the camera unit 5.

The Fabry-Perot interference filter 10 is disposed at a position where a chief ray passing through the outer edge Ra of the imaging region R of the light L formed by the second lens portion 24 intersects the optical axis A. Accordingly, the size of the imaging region R of the light L formed by the second lens portion 24 can be keep constant regardless of the size of the first aperture P1. Therefore, the image capturing element 52 of the same size can be used regardless of the size of the first aperture P1. In addition, since the angle of incidence of the light L on the Fabry-Perot interference filter 10 becomes constant, it is becomes easy to correct the wavelength shift in the Fabry-Perot interference filter 10.

The first aperture P1 is located on the incident portion 21a side with respect to the mirror portions 14 and 15. Accordingly, stray light or light having a large angle of incidence can be cut by the first aperture P1 before being incident on the mirror portions 14 and 15, and noise can be reduced.

The optical system 22 includes the second aperture P2 disposed between the Fabry-Perot interference filter 10 and the first lens portion 23. Accordingly, the light L can be narrowed to a desired angle range by the first aperture P1 and the second aperture P2, and the resolution in capturing an image for each wavelength can be improved. Since the first aperture P1 is formed integrally with the Fabry-Perot interference filter 10, it is difficult to increase the thickness (depth) of the first aperture P1. In this regard, since the adjustment of the thickness of the second aperture P2 is easier compared to the first aperture P1, providing the second aperture P2 in addition to the first aperture P1 is effective.

The second aperture P2 is configured as the opening 36 formed in the support 31, and the Fabry-Perot interference filter 10 is fixed to the support 31. Accordingly, the Fabry-Perot interference filter 10 (first aperture P1) can be suitably fixed near the second aperture P2.

The support 31 is sandwiched and fixed between the first portion 211 of the housing 21 (the first lens holder that holds the first lens portion 23) and the second portion 212 of the housing 21 (the second lens holder that holds the second lens portion 24). Accordingly, the support 31 can be suitably fixed.

When viewed in the optical axis direction D, the area of the incident region of the light L at the incident position on the first aperture P1 may be equal to or less than 110% of the area of the first aperture P1. In this case, the light utilization efficiency can be improved.

The Fabry-Perot interference filter 10 includes the substrate 11 including the first surface 11a and the second surface 11b, and the first laminated structure 12 disposed on the first surface 11a. The first laminated structure 12 includes the first laminate 122 disposed on the first surface 11a and including the mirror portion 14, and the second laminate 124 disposed on the side opposite the substrate 11 with respect to the first laminate 122 and including the mirror portion 15. In this case as well, an image can be satisfactorily captured by the hyperspectral camera 1.

The Fabry-Perot interference filter 10 includes the second laminated structure 13 disposed on the second surface 11b of the substrate 11, and the recess 18 is formed on the surface 13a of the second laminated structure 13 opposite the substrate 11. The recess 18 overlaps the first aperture P1 when viewed in the optical axis direction D. Accordingly, since the recess 18 is formed, the light L can easily transmit through a portion of the Fabry-Perot interference filter 10 that overlaps the first aperture P1, and the light utilization efficiency can be improved.

The first aperture P1 is formed by providing the light-shielding layer 135 in a region of the Fabry-Perot interference filter 10 other than the light-transmitting region 10a while not providing the light-shielding layer 135 in the light-transmitting region 10a. Accordingly, the first aperture P1 can be formed integrally with the Fabry-Perot interference filter 10.

### Modification Examples

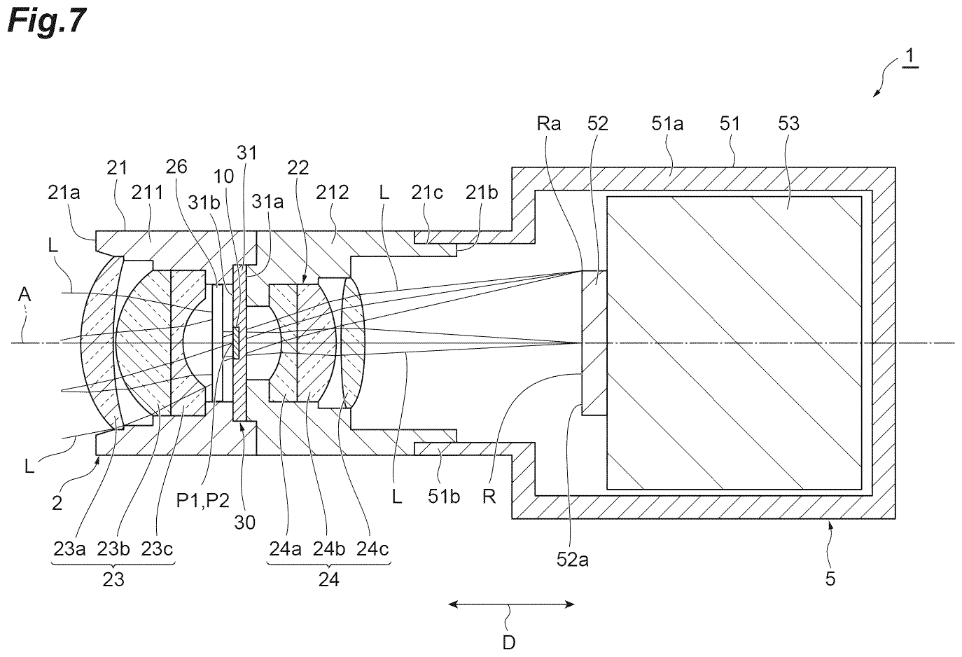

As in a first modification example shown in FIG. 7, the optical system 22 may further include a reduction optical system 26 (additional optical system) that is disposed between the Fabry-Perot interference filter 10 and the first lens portion 23, and that reduces the width of the light L. In this example, the reduction optical system 26 is disposed between the first lens portion 23 and the second aperture P2. The reduction optical system 26 includes, for example, a plurality of lenses. With the first modification example as well, similarly to the above-described embodiment, an image can be satisfactorily captured by the hyperspectral camera 1. In addition, the light utilization efficiency can be improved by reducing the width of the light L using the reduction optical system 26 before being incident on the Fabry-Perot interference filter 10.

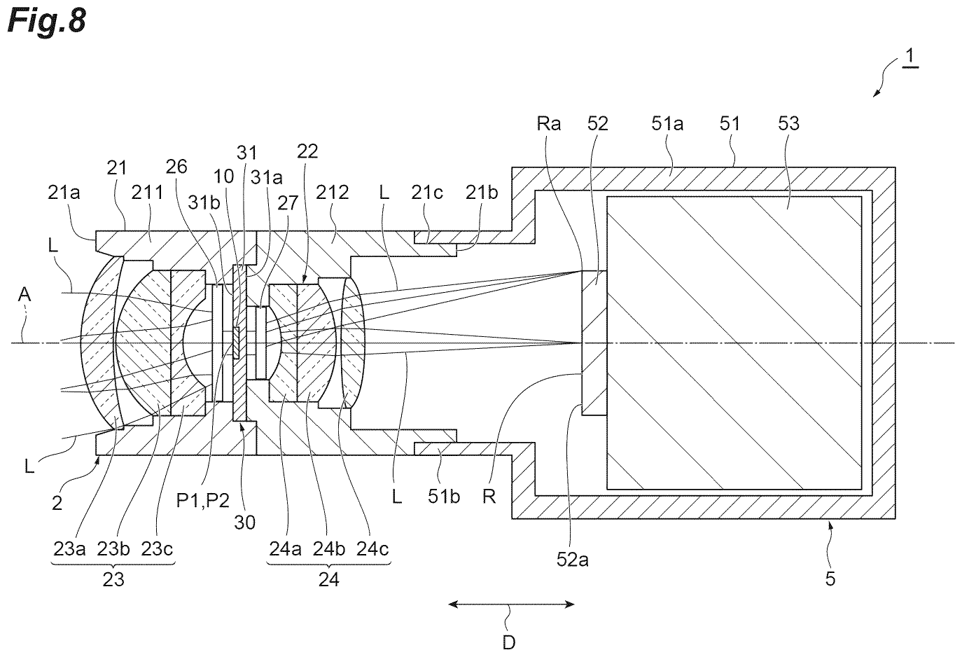

In a second modification example shown in FIG. 8, the reduction optical system 26 is configured as an optical system that reduces the width of the light L and that collimates the light L (reduces the angle of incidence on the Fabry-Perot interference filter 10, namely, the angle with respect to the optical axis direction D). Namely, the reduction optical system 26 makes the angle of incidence of the light L on the Fabry-Perot interference filter 10 smaller than the angle of the light L traveling from the first lens portion 23 toward the Fabry-Perot interference filter 10 (reduction optical system 26). In addition, the optical system 22 further includes an optical system 27 that is disposed between the Fabry-Perot interference filter 10 and the second lens portion 24 and that returns the angle of the light L to an angle before being collimated (returns the angle with respect to the optical axis direction D to an original angle). With the second modification example as well, similarly to the above-described embodiment, an image can be satisfactorily captured by the hyperspectral camera 1. In addition, the light utilization efficiency can be improved by reducing the width of the light L before being incident on the Fabry-Perot interference filter 10. In addition, the occurrence of wavelength shift can be suppressed by collimating the light L before being incident on the Fabry-Perot interference filter 10. Note that, in the second modification example, the optical system 22 may include an additional optical system that collimates the light L without reducing the width of the light L, instead of the reduction optical system 26. In this case as well, the occurrence of wavelength shift can be suppressed.

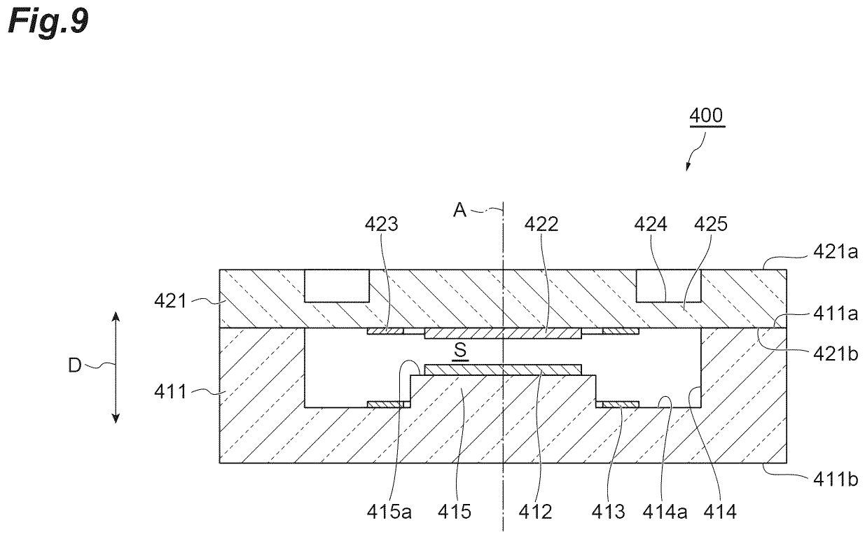

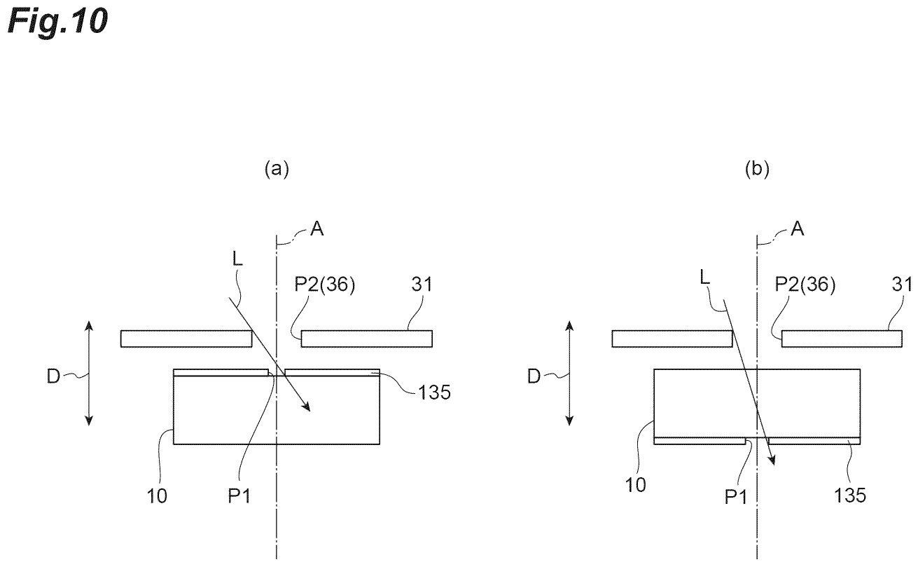

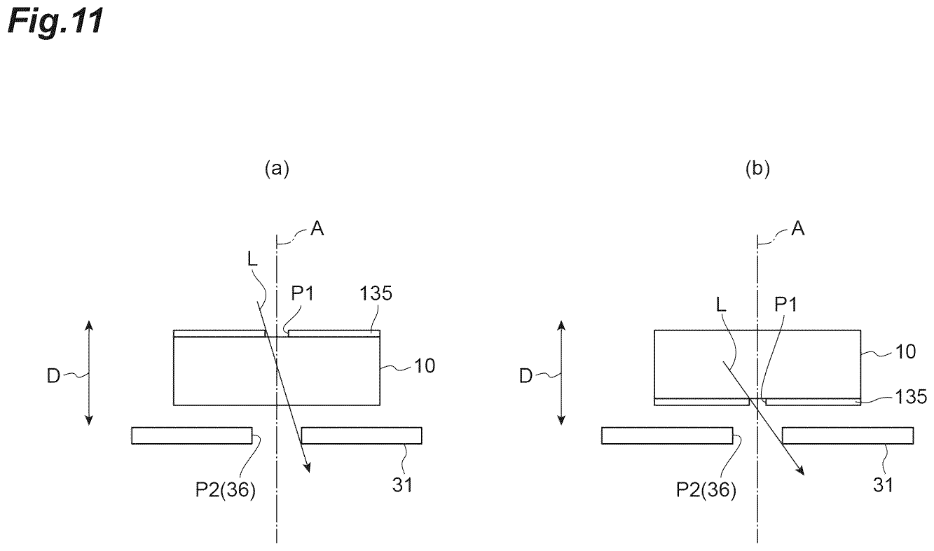

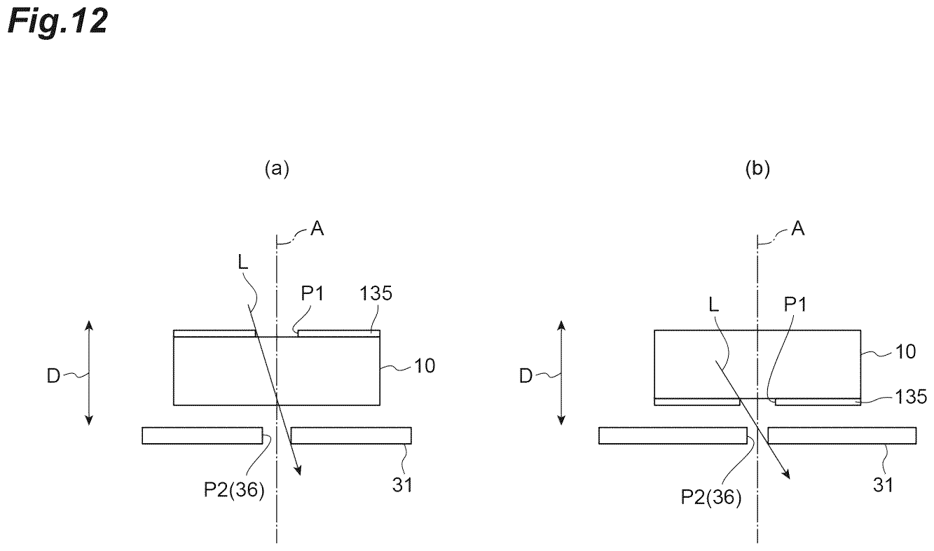

A Fabry-Perot interference filter 400 of a third modification example shown in FIG. 9 may be used instead of the Fabry-Perot interference filter 10. The Fabry-Perot interference filter 400 includes a substrate layer 411 (first substrate), a mirror portion 412, and a drive electrode 413. The substrate layer 411 has a surface 411a and a surface 411b facing each other. The substrate layer 411 is made of a light-transmitting material. The mirror portion 412 is, for example, a metal film, a dielectric multilayer film, or a composite film thereof. The drive electrode 413 is made of, for example, a metal material.

The Fabry-Perot interference filter 400 further includes a substrate layer 421 (second substrate), a mirror portion 422, and a drive electrode 423. The substrate layer 421 has a surface 421a and a surface 421b facing each other. The substrate layer 421 is made of a light-transmitting material. The mirror portion 422 is, for example, a metal film, a dielectric multilayer film, or a composite film thereof. The drive electrode 423 is made of, for example, a metal material.

A recess 414 is formed on the surface 411a of the substrate layer 411. A protrusion 415 is provided on a bottom surface 414a of the recess 414. When the bottom surface 414a is taken as a reference, a height of an end surface 415a of the protrusion 415 is lower than a height of the surface 411a of the substrate layer 411. The mirror portion 412 is provided on the end surface 415a (first surface) of the protrusion 415. The drive electrode 413 is provided on the bottom surface 414a of the recess 414 so as to surround the protrusion 415. The drive electrode 413 is electrically connected to, for example, an electrode pad (not shown) via a wiring (not shown) provided on the substrate layer 411. The electrode pad is provided, for example, in a region of the substrate layer 411 that is accessible from the outside.

The surface 421b of the substrate layer 421 is bonded to the surface 411a of the substrate layer 411, for example, by plasma bonding. The mirror portion 422 and the drive electrode 423 are provided on the surface 421b (second surface) of the substrate layer 421. The surface 421b of the substrate layer 421 faces the end surface 415a of the substrate layer 411 in the optical axis direction D. The mirror portion 422 faces the mirror portion 412 in the optical axis direction D with the air gap S therebetween. The drive electrode 423 is provided on the surface 421b of the substrate layer 421 so as to surround the mirror portion 422, and faces the drive electrode 413 with the air gap S therebetween. The drive electrode 423 is electrically connected to, for example, an electrode pad (not shown) via a wiring (not shown) provided on the substrate layer 421. The electrode pad is provided, for example, in a region of the substrate layer 421 that is accessible from the outside.

A groove 424 is formed on the surface 421a of the substrate layer 421 so as to surround the mirror portion 422 and the drive electrode 423 when viewed in the optical axis direction D. The groove 424 extends in an annular shape. A portion of the substrate layer 421 surrounded by the groove 424 is movable in a direction in which the pair of mirror portions 412 and 422 face each other, with a portion in which the groove 424 is formed serving as a holding portion 425 having a diaphragm shape.

In addition, the holding portion 425 having a diaphragm shape may be configured by forming a groove, which surrounds the mirror portion 422 and the drive electrode 423 when viewed in the optical axis direction D, on at least one of the surface 421a and the surface 421b of the substrate layer 421. A holding portion having a diaphragm shape may be configured in the substrate layer 411 by forming a groove, which surrounds the mirror portion 412 and the drive electrode 413 when viewed in the optical axis direction D, in the substrate layer 411. Instead of the holding portion having a diaphragm shape, the holding portion may be configured as a plurality of beams disposed radially.

In the Fabry-Perot interference filter 400, when a potential difference is generated between the drive electrode 413 and the drive electrode 423 by applying a voltage to the drive electrode 413 and the drive electrode 423, an electrostatic force corresponding to the potential difference is generated between the drive electrode 413 and the drive electrode 423. Due to the generation of an electrostatic force between the drive electrode 413 and the drive electrode 423, the portion of the substrate layer 421 surrounded by the groove 424 is attracted to a substrate layer 411 side, and the distance between the mirror portion 412 and the mirror portion 422 is adjusted. Accordingly, light having a wavelength corresponding to the distance between mirror portion 412 and mirror portion 422 transmits through the Fabry-Perot interference filter 400.

Even when the Fabry-Perot interference filter 400 of the third modification example is used instead of the Fabry-Perot interference filter 10, similarly to the above-described embodiment, an image can be satisfactorily captured by the hyperspectral camera 1. In addition, in the Fabry-Perot interference filter 400 as well, the first aperture P1 may be formed integrally with the Fabry-Perot interference filter 400, for example, by forming a light-shielding layer on the surface 411b of the substrate layer 411 opposite the substrate layer 421. Similarly to the above-described embodiment, the first aperture P1 can be formed by providing a light-shielding layer in a region of the Fabry-Perot interference filter 400 other than a light-transmitting region while not providing the light-shielding layer in the light-transmitting region. Alternatively, the first aperture P1 may be formed integrally with the Fabry-Perot interference filter 400 by forming a light-shielding layer on the surface 421a of the substrate layer 421 opposite the substrate layer 411. In this case, the first aperture P1 is located on a side opposite the incident portion 21a (emitting portion 21b side) with respect to the mirror portions 412 and 422 of the Fabry-Perot interference filter 1400.

In the above-described embodiment, the Fabry-Perot interference filter 10 is in contact with the support 31; however, as another modification example, as shown in (a) of FIG. 10, the Fabry-Perot interference filter 10 may be disposed away from the support 31. For example, an air gap may be formed between the Fabry-Perot interference filter 10 and the support 31, or a glass member may be disposed between the Fabry-Perot interference filter 10 and the support 31. When the Fabry-Perot interference filter 10 is disposed away from the support 31, the effect of suppressing the angle of incidence by the above-described double aperture structure is noticeably exhibited.

As shown in (b) of FIG. 10, the first aperture P1 may be located on the side opposite the incident portion 21a (emitting portion 21b side) with respect to the mirror portions 14 and 15 of the Fabry-Perot interference filter 10. In this case, the light L that has transmitted through the Fabry-Perot interference filter 10 passes through the first aperture P1. For example, in the above-described embodiment, such disposition can be realized by fixing the Fabry-Perot interference filter 10 to the support 31 in an opposite direction with respect to the optical axis direction D. Alternatively, instead of forming the light-shielding layer 135 on the incident portion 21a side with respect to the mirror portions 14 and 15 to provide the first aperture P1 in the above-described embodiment, the above-described disposition can also be realized by forming the light-shielding layer 135 on the side opposite the incident portion 21a with respect to the mirror portions 14 and 15 (for example, on a surface of the Fabry-Perot interference filter 10 opposite the incident portion 21a) to provide the first aperture P1.

As shown in (a) of FIG. 11, the second aperture P2 may be located on the side opposite the incident portion 21a (emitting portion 21b side) with respect to the mirror portions 14 and 15 of the Fabry-Perot interference filter 10. Namely, the second aperture P2 may be disposed between the Fabry-Perot interference filter 10 and the second lens portion 24.

As shown in (b) of FIG. 11, both the first aperture P1 and the second aperture P2 may be located on the side opposite the incident portion 21a (emitting portion 21b side) with respect to the mirror portions 14 and 15 of the Fabry-Perot interference filter 10.

As shown in (a) and (b) of FIG. 12, when the second aperture P2 is located on the side opposite the incident portion 21a with respect to the mirror portions 14 and 15 of the Fabry-Perot interference filter 10, the diameter (width) of the second aperture P2 may be smaller than the diameter (width) of the first aperture P1. With the above-described modification examples shown in FIGS. 10 to 12 as well, similarly to the above-described embodiment, an image can be satisfactorily captured by the hyperspectral camera 1.

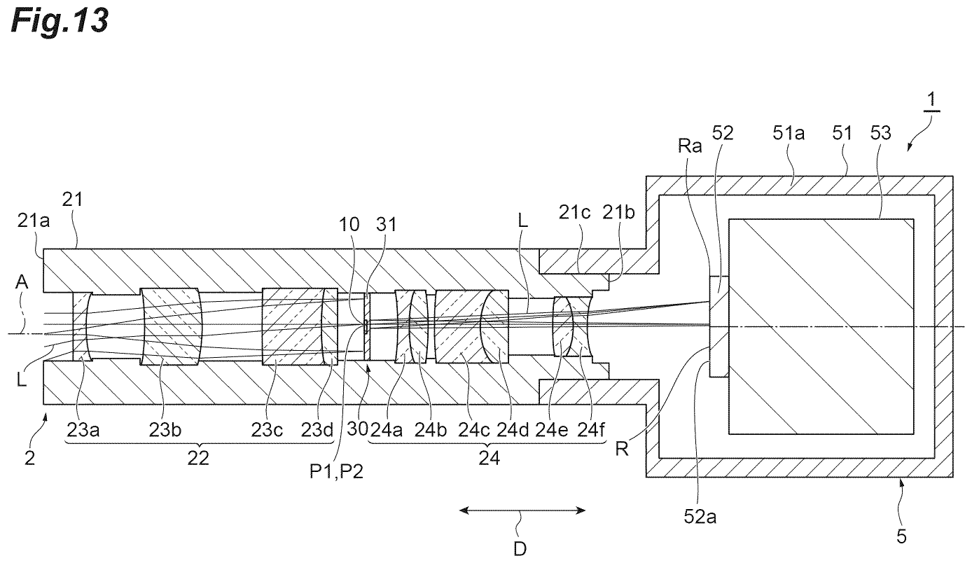

In the hyperspectral camera 1 shown in FIG. 13, the first lens portion 23 does not focus the light L traveling from the incident portion 21a toward the Fabry-Perot interference filter 10, but collimates the light L. In this example, the first lens portion 23 includes four lenses 23a, 23b, 23c, and 23d arranged along the optical axis direction D. The second lens portion 24 includes six lenses 24a, 24b, 24c, 24d, 24e, and 24f arranged along the optical axis direction D. With such a modification example as well, similarly to the above-described embodiment, an image can be satisfactorily captured by the hyperspectral camera 1.

The present disclosure is not limited to the embodiment and the modification examples described above. For example, the material and shape of each configuration are not limited to the material and shape described above, and various materials and shapes can be adopted.

The Fabry-Perot interference filter 10 may not be fixed to the support 31, and may be fixed to a member separate from the member in which the second aperture P2 is formed. The second aperture P2 may not be configured as the opening 36 formed in the support 31, and for example, an aperture member in which an opening constituting the second aperture P2 is formed may be provided separately from the support 31. The second aperture P2 may be omitted.

The method for fixing the support 31 is not limited to the above-described example, and the support 31 may not be sandwiched and fixed between the first portion 211 of the housing 21 and the second portion 212 of the housing 21. In the above-described embodiment, the first lens holder that holds the first lens portion 23 is configured by the first portion 211 of the housing 21, and the second lens holder that holds the second lens portion 24 is configured by the second portion 212 of the housing 21; however, the first lens holder and the second lens holder may be provided separately from the housing 21. In this case as well, the support 31 may be sandwiched and fixed between the first lens holder and the second lens holder. The housing 21 may not be divided in the optical axis direction D, and may be composed of a single member. In this case as well, the support 31 may be fixed to the housing 21.

When viewed in the optical axis direction D, the area of the incident region of the light L at the incident position on the first aperture P1 may be larger than 110% of the area of the first aperture P1. When viewed in the optical axis direction D, the width of the light L at the incident position on the second aperture P2 may be narrower than the width of the second aperture P2. Namely, the light L may not necessarily be narrowed by the second aperture P2.

It is sufficient if at least a part of the recess 18 overlaps the first aperture P1 when viewed in the optical axis direction D, and when viewed in the optical axis direction D, an outer edge of the recess 18 may be located outside an outer edge of the first aperture P1 or the outer edge of the first aperture P1 may be located outside the outer edge of the recess 18. In the above-described embodiment, the light-shielding layer 135 may not formed over the entirety of the surface 13a of the second laminated structure 13, and when viewed in a Z direction, the outer edge of the first aperture P1 may be located outside the outer edge of the recess 18. The recess 18 may not be provided. An optical device other than the camera unit 5 may be attached to the attachment portion 21c of the housing 21. The hyperspectral camera 1 may further include a ring light for supplementing the amount of light, which is disposed to face the incident portion 21a of the lens unit 2.

### REFERENCE SIGNS LIST

1: hyperspectral camera, 2: lens unit (hyperspectral camera lens unit), 5: camera unit (optical device), 10: Fabry-Perot interference filter, 10a: light-transmitting region, 11: substrate, 11a: first surface, 11b: second surface, 12: first laminated structure, 122: first laminate, 124: second laminate, 13: second laminated structure, 13a: surface, 135: light-shielding layer, 14, 15: mirror portion, 18: recess, 21: housing, 21a: incident portion, 21b: emitting portion, 21c: attachment portion, 22: optical system, 23: first lens portion, 24: second lens portion, 26: reduction optical system (additional optical system), 31: support, 36: opening, 52: image capturing element, 400: Fabry-Perot interference filter, 411: substrate layer (first substrate), 412, 422: mirror portion, 415a: end surface (first surface), 421: substrate layer (second substrate), 421b: surface (second surface), P1: first aperture, P2: second aperture, A: optical axis, D: optical axis direction, L: light, R: imaging region, Ra: outer edge.

1: A hyperspectral camera lens unit, comprising:
a housing including an incident portion on which light is incident, an emitting portion from which the light is emitted, and an attachment portion to which an optical device is detachably attached; and
an optical system disposed inside the housing,
wherein the optical system includes:
a Fabry-Perot interference filter that includes a pair of mirror portions having a variable distance therebetween, and that transmits the light from the incident portion according to the distance between the pair of mirror portions;
a first aperture which is formed integrally with the Fabry-Perot interference filter, and through which the light traveling toward the Fabry-Perot interference filter or the light that has transmitted through the Fabry-Perot interference filter passes;
a first lens portion that focuses or collimates the light traveling from the incident portion toward the Fabry-Perot interference filter; and
a second lens portion that images the light that transmits through the Fabry-Perot interference filter and is emitted from the emitting portion,
wherein when viewed in an optical axis direction, a width of the light at an incident position on the first aperture is wider than a width of the first aperture.

2: The hyperspectral camera lens unit according to claim 1,
wherein the Fabry-Perot interference filter is disposed at a position where a chief ray passing through an outer edge of an imaging region of the light formed by the second lens portion intersects an optical axis of the light.

3: The hyperspectral camera lens unit according to claim 1,
wherein the first aperture is located on a side of the incident portion with respect to the pair of mirror portions.

4: The hyperspectral camera lens unit according to claim 1,
wherein the optical system further includes a second aperture disposed between the Fabry-Perot interference filter and the first lens portion or between the Fabry-Perot interference filter and the second lens portion.

5: The hyperspectral camera lens unit according to claim 4,
wherein the second aperture is configured as an opening formed in a support, and
the Fabry-Perot interference filter is fixed to the support.

6: The hyperspectral camera lens unit according to claim 5, further comprising:
a first lens holder that holds the first lens portion; and
a second lens holder that holds the second lens portion,
wherein the support is sandwiched and fixed between the first lens holder and the second lens holder.

7: The hyperspectral camera lens unit according to claim 1,
wherein when viewed in the optical axis direction, an area of an incident region of the light at an incident position on the first aperture is equal to or less than 110% of an area of the first aperture.

8: The hyperspectral camera lens unit according to claim 1,
wherein the optical system further includes an additional optical system that is disposed between the Fabry-Perot interference filter and the first lens portion, and that reduces the width of the light.

9: The hyperspectral camera lens unit according to claim 1,
wherein the optical system further includes an additional optical system that is disposed between the Fabry-Perot interference filter and the first lens portion, and that collimates the light.

10: The hyperspectral camera lens unit according to claim 9,
wherein the additional optical system reduces the width of the light.

11: The hyperspectral camera lens unit according to claim 1,
wherein the Fabry-Perot interference filter includes a substrate including a first surface and a second surface opposite the first surface, and a first laminated structure disposed on the first surface, and
the first laminated structure includes a first laminate disposed on the first surface and including one of the pair of mirror portions, and a second laminate disposed on a side opposite the substrate with respect to the first laminate and including the other of the pair of mirror portions.

12: The hyperspectral camera lens unit according to claim 11,
wherein the Fabry-Perot interference filter further includes a second laminated structure disposed on the second surface of the substrate,
a recess is formed on a surface of the second laminated structure opposite the substrate, and
at least a part of the recess overlaps the first aperture when viewed in the optical axis direction.

13: The hyperspectral camera lens unit according to claim 1,
wherein the Fabry-Perot interference filter includes a first substrate including a first surface, a second substrate including a second surface facing the first surface, one of the pair of mirror portions formed on the first surface, and the other of the pair of mirror portions formed on the second surface.

14: The hyperspectral camera lens unit according to claim 1,
wherein the first aperture is formed by providing a light-shielding layer in a region of the Fabry-Perot interference filter other than a light-transmitting region while not providing the light-shielding layer in the light-transmitting region.

15: A hyperspectral camera, comprising:
the hyperspectral camera lens unit according to claim 1; and
a camera unit that is the optical device attached to the attachment portion of the housing, the camera unit including an image capturing element that image-captures the light emitted from the emitting portion.
